(19) United States
(12) Patent Application Publication
(10) Pub. No.: US 2024/0283865 A1
(43) Pub. Date: Aug. 22, 2024

(54) ELECTRONIC DEVICE, PROGRAM AND DISPLAY METHOD

(71) Applicant: KYOCERA Corporation, Kyoto (JP)

(72) Inventors: Tomokazu ADACHI, Yokohama-shi, Kanagawa (JP); Shingo ITO, Kyoto-shi, Kyoto (JP); Kai SHIMIZU, Yokohama-shi, Kanagawa (JP)

(73) Assignee: KYOCERA Corporation, Kyoto (JP)

(21) Appl. No.: 18/571,356

(22) PCT Filed: Jun. 30, 2021
(86) PCT No.: PCT/JP2021/024752

§ 371 Date: Dec. 18, 2023

(51) Int. Cl. H04M 1/72469; H04M 1/02

(52) U.S. Cl. CPC H04M 1/72469; H04M 1/0266

(57) ABSTRACT

An electronic device includes a display and at least one processor. The at least one processor acquires, from a communication network theoretically divided into a plurality of slices each corresponding to a service type, identifiers each assigned to a respective one of the plurality of slices via a communication interface. The at least one processor displays, based on the acquired identifiers, an image indicating predetermined information about the communication network on the display.

### TECHNICAL FIELD

The present disclosure relates to an electronic device, a program and a display method.

### BACKGROUND OF INVENTION

In recent years, cellular communication systems that comply with the fifth-generation (5G) cellular communication standard have attracted attention. In such cellular communication systems, not only public cellular communication networks operated by communication carriers, but also local cellular communication networks operated by general companies, organizations, or individuals are expected to be established. The local cellular communication network may be referred to as a private cellular communication network or a non-public cellular communication network.

The local cellular communication network can be flexibly established and used by various entities according to regional needs or the individual needs of industrial sectors. Further, the local cellular communication network is less congested and has a better propagation environment than the public cellular communication network, and therefore is expected to provide better service to electronic devices.

When the public cellular communication network and the local cellular communication network are both available, an electronic device has an option to select a connection destination from these two types of cellular communication networks. As a common method, the electronic device preferentially selects a home network, which is a cellular communication network to which the electronic device is subscribed, or selects a cellular communication network that provides the highest received power at the electronic device.

### CITATION LIST

### Non Patent Literature

Non Patent Literature 1: 3GPP Technical Report “3GPP TR 23.734 V16.2.0: Study on enhancement of 5G System (5GS) for vertical and Local Area Network (LAN) services (Release 16)”, June, 2019

### SUMMARY

According to the present disclosure, an electronic device includes a display and at least one processor. The at least one processor acquires, from a communication network theoretically divided into a plurality of slices each corresponding to a service type, identifiers each assigned to a respective one of the plurality of slices via a communication interface. The at least one processor displays, based on the acquired identifiers, an image indicating predetermined information about the communication network on the display.

According to the present disclosure, a program causes a computer installed in an electronic device equipped with a display to execute processing of acquiring, from a communication network theoretically divided into a plurality of slices each corresponding to a service type, identifiers each assigned to a respective one of the plurality of slices via a communication interface. The program causes the computer to execute processing of displaying, based on the acquired identifiers, an image indicating predetermined information about the communication network on the display.

According to the present disclosure, a display method is a display method in an electronic device equipped with a display. The display method acquires, from a communication network theoretically divided into a plurality of slices each corresponding to a service type, identifiers each assigned to a respective one of the plurality of slices via a communication interface. The display method displays, based on the acquired identifiers, an image indicating predetermined information about the communication network on the display.

### BRIEF DESCRIPTION OF THE DRAWINGS

FIG. 1 is a view illustrating a configuration of a communication system according to an embodiment.

FIG. 2 is a diagram illustrating a configuration of an electronic device according to an embodiment.

FIG. 3 is a flowchart illustrating a control procedure of network-related image display processing.

FIG. 4 is a diagram illustrating operations of specifying a provided service type according to an embodiment.

FIG. 5 is a view illustrating an example of a network-related image displayed on a display.

FIG. 6 is a view illustrating an example of a network-related image displayed on the display.

FIG. 7 is a view illustrating an example of a network-related image displayed on the display.

FIG. 8 is a view illustrating an example of a network-related image displayed on the display.

FIG. 9 is a view illustrating an example of a network-related image displayed on the display.

FIG. 10 is a view illustrating an example of a network-related image displayed on the display.

FIG. 11 is a view illustrating an example of a network-related image displayed on the display.

FIG. 12 is a view illustrating an example of a network-related image displayed on the display.

FIG. 13 is a view illustrating a user's movement from Area 1 to Area 2.

FIG. 14 is a view illustrating an example of a network-related image displayed on the display.

FIG. 15 is a view illustrating an example of a network-related image displayed on the display.

FIG. 16 is a view illustrating an example of a network-related image displayed on the display.

FIG. 17 is a view illustrating an example of a network-related image displayed on the display.

FIG. 18 is a view illustrating an example of a network-related image displayed on the display.

FIG. 19 is a view illustrating an example of a network-related image displayed on the display.

FIG. 20 is a view illustrating an example of a network-related image displayed on the display.

FIG. 21 is a view illustrating an example of a network-related image displayed on the display.

FIG. 22 is a view illustrating an example of a network-related image displayed on the display.

FIG. 23 is a view illustrating an example of a network-related image displayed on the display.

FIG. 24 is a view illustrating an example of a network-related image displayed on the display.

FIG. 25 is a view illustrating an example of a guide image displayed on the display.

FIG. 26 is a view illustrating an example of a guide image displayed on the display.

FIG. 27 is a view illustrating an example of a map image displayed on the display.

FIG. 28 is a perspective view schematically illustrating an electronic device according to Variation 1.

FIG. 29 is a view illustrating an example of a viewing area and a virtual image viewed by a user wearing the electronic device of Variation 1.

FIG. 30 is a view explaining the viewing area in a space.

FIG. 31 is a diagram illustrating a configuration of the electronic device of Variation 1.

FIG. 32 is a flowchart illustrating a control procedure of network-related image display processing.

FIG. 33 is a view illustrating an example of a network-related image displayed on a display.

FIG. 34 is a view illustrating an example of a network-related image displayed on the display.

FIG. 35 is a schematic view illustrating a configuration of a display system according to Variation 2.

FIG. 36 is a block diagram illustrating a main functional structure of an information processing device.

### DESCRIPTION OF EMBODIMENTS

In a case where a local cellular communication network is established for the purpose of providing a specific service, the type of the service provided by the local cellular communication network may be limited. On the other hand, a public cellular communication network may provide general-purpose services but may not provide a specialized service that meets regional needs and individual needs of industrial sectors.

Therefore, if the general connection destination selection method described above is used while both the public cellular communication network and the local cellular communication network are available, the service that the user of an electronic device wishes to use is not necessarily provided in the cellular communication network to which the user is connected.

Therefore, the present disclosure intends to facilitate the appropriate selection of a cellular communication network to connect to while both the public cellular communication network and the local cellular communication network are available.

Embodiments are described below with reference to the drawings. In the description of the drawings, the same or similar components are denoted by the same or similar reference numerals.

### [Configuration of Communication System]

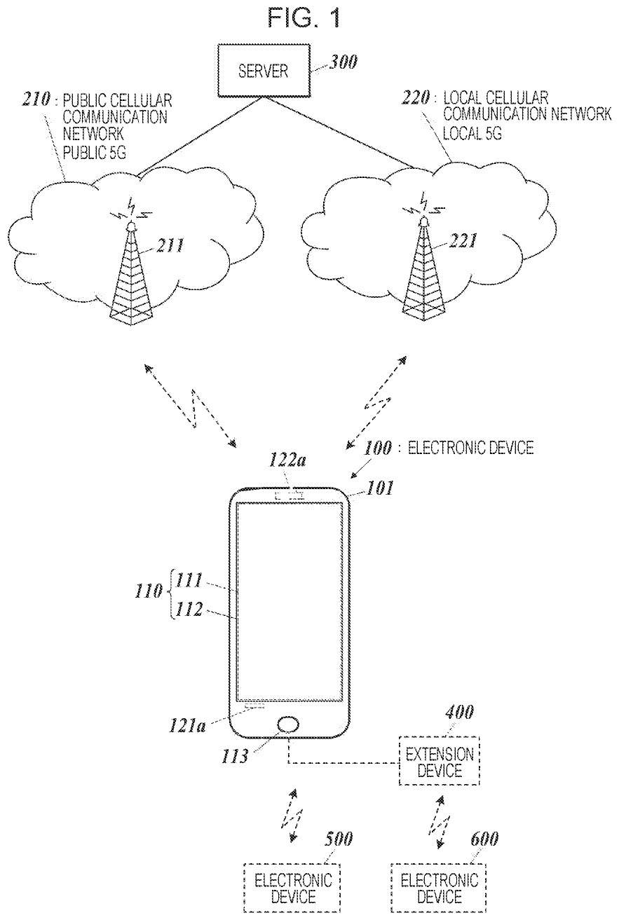

First, according to an embodiment, a configuration of a communication system is described. FIG. 1 is a view illustrating a configuration of the communication system according to the embodiment. In the embodiment, the communication system is a cellular communication system that complies with the 5th generation (5G) 3GPP standard.

As illustrated in FIG. 1, in the embodiment, the communication system includes an electronic device 100, a public cellular communication network 210, a local cellular communication network 220, and a server 300.

The electronic device 100 is a device that has a function of performing cellular communication with a cellular communication network. The electronic device 100 can be any device that has a function of performing cellular communication and has a user interface (UI). For example, the electronic device 100 is a smartphone, a tablet terminal, a notebook PC (Personal Computer), a wearable terminal device or a mobile router. In the 3GPP standard, the electronic device 100 is referred to as UE (User Equipment).

The public cellular communication network 210 is a cellular communication network operated by a communication carrier. The public cellular communication network 210 is also referred to as public 5G. The communication carrier that operates the public cellular communication network 210 is licensed nationwide.

The local cellular communication network 220 is a cellular communication network that can be flexibly established and used by various entities according to regional needs or the individual needs of industrial sectors. The local cellular communication network 220 is also referred to as local 5G. For example, a general company, an organization or an individual may receive a frequency allocation to operate its own local cellular communication network 220. The local cellular communication network 220 is licensed only for a local area, such as within a facility of a general company.

The public cellular communication network 210 and the local cellular communication network 220 comply with the 3GPP standard for 5G. The public cellular communication network 210 includes a base station 211, and the public cellular communication network 210 includes a base station 221. In FIG. 1, only one base station is included in each cellular communication network, but in reality, each cellular communication network may include a plurality of base stations. In the 3GPP standard for 5G, the base station is referred to as gNB. The base station constitutes a NG-RAN (Next Generation Radio Access Network), which is a 5G radio access network.

Each of the public cellular communication network 210 and the local cellular communication network 220 further includes a 5GC (5G core network), which is a core network of 5G. In 5G, it is assumed that a wide variety of electronic devices are connected to the cellular communication network, and it is necessary to support a variety of services with different requirements, such as high speed, large capacity, high reliability and low latency. Therefore, the 5GC is theoretically divided into a plurality of slices corresponding to different services (service requirements).

Here, each slice is assigned an identifier called S-NSSAI (Single-Network Slice Selection Assistance Information). Each slice is associated with one service type (SST). The eMBB (high speed, large capacity), mIoT (multi-connection, power saving, low cost), and URLLC (low latency, high reliability) are service types defined in the standard, but service types not defined in the standard can also be used.

In a case where the local cellular communication network 220 is established for the purpose of providing a specific service, the type of service (SST) provided by the local cellular communication network 220 may be limited. On the other hand, the public cellular communication network 210 may provide general-purpose services but may not provide a specialized service that meet regional needs or individual needs of industrial sectors. Note that “service provided by the cellular communication network” can also be regarded as a “function supported by the cellular communication network”.

The server 300 communicates with the electronic device 100 via the public cellular communication network 210 or the local cellular communication network 220. The server 300 may be a server for managing the local cellular communication network 220.

At least one electronic device 500 may be wired or wirelessly connected to the electronic device 100. The electronic device 500 establishes, for example, a WLAN (Wireless Local Area Network) connection with the electronic device 100 and communicates, via the electronic device 100, with a cellular communication network to which the electronic device 100 is connected. This enables the electronic device 500 to communicate with the cellular communication network via the electronic device 100, even if the electronic device 500 does not have a cellular communication function.

An extension device 400 may be wired or wirelessly connected to the electronic device 100. The extension device 400 establishes, for example, a USB (Universal Serial Bus) connection with the electronic device 100. The extension device 400 may have a function of feeding power to the electronic device 100. The extension device 400 may be a cradle.

At least one electronic device 600 may be wired or wirelessly connected to the extension device 400. The electronic device 600 establishes, for example, a WLAN connection with the extension device 400 and communicates, via the extension device 400 and the electronic device 100, with a cellular communication network to which the electronic device 100 is connected. This enables the electronic device 600 to communicate with the cellular communication network via the extension device 400 and the electronic device 100, even if the electronic device 600 does not have a cellular communication function.

### [Configuration of Electronic Device]

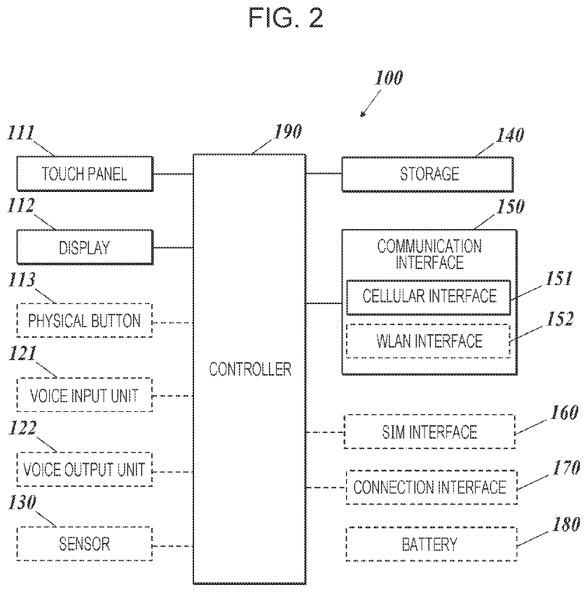

In an embodiment, a configuration of the electronic device 100 is described. As illustrated in FIG. 1, the electronic device 100 includes a touch panel display 110, at least one physical button 113, a microphone 121a, and a speaker 122a. However, the components indicated by the dashed line in FIGS. 1 and 2 are not essential.

The touch panel display 110 has a display surface exposed from a housing 101 of the electronic device 100. The touch panel display 110 includes a touch panel 111 and a display 112.

The touch panel 111 receives operation input (touch input) to the electronic device 100. The method of detecting touch can be any method, for example, a resistance film method, an electrostatic capacitance method or the like. The display 112 outputs an image.

The display 112 displays objects such as characters (including symbols), images, and graphics on the screen. The display 112 is, for example, a liquid crystal display or an organic EL (electro luminescence) display. In the touch panel display 110, the display 112 overlaps with the touch panel 111, and the display area of the display 112 overlaps with the touch panel 111.

The physical button 113 receives operation input (press) to the electronic device 100. The physical button 113 is, for example, a home button, a power button, a voice adjustment button, or the like.

The microphone 121a receives voice input to the electronic device 100. The microphone 121a picks up ambient sound.

The speaker 122a performs voice output. Further, the speaker 122a outputs voice of telephone calls and information on various programs.

FIG. 2 is a diagram illustrating a configuration of the electronic device 100 according to an embodiment.

As illustrated in FIG. 2, the electronic device 100 includes the touch panel 111, the display 112, the physical button 113, a voice input unit 121, a voice output unit 122, a sensor 130, a storage 140, a communication interface 150, a SIM (Subscriber Identity Module) interface 160, a connection interface 170, a battery 180, and a controller 190.

The touch panel 111 input a signal corresponding to touch operation to the controller 190. The display 112 displays objects such as characters, images, and graphics on a screen based on a signal input from the controller 190.

The voice input unit 121 inputs, to the controller 190, a signal corresponding to the input voice. The voice input unit 121 may be the microphone 121a illustrated in FIG. 1, or may be an input interface to which an external microphone can be connected. The external microphone may be provided in the extension device 400.

The voice output unit 122 outputs voice based on the signal input from the controller 190. The voice output unit 122 may be the speaker 122a illustrated in FIG. 1, or may be an output interface to which an external speaker can be connected. The external speaker may be provided in the extension device 400.

The sensor 130 detects various physical quantities and data and outputs the detection result to the controller 190. For example, the sensor 130 includes a position sensor, an acceleration sensor, and a temperature sensor. The position sensor detects the position thereof and outputs position data to the controller 190. The position sensor may include a GNSS (Global Navigation Satellite System) receiver. The GNSS receiver performs positioning based on a GNSS satellite signal and outputs GNSS position data indicating the geographic location (latitude and longitude) thereof to the controller 190. The acceleration sensor detects the acceleration applied thereto and outputs acceleration data to the controller 190. The acceleration sensor may be a multi-axis acceleration sensor that includes a plurality of acceleration sensors. The temperature sensor detects the temperature and outputs temperature data to the controller 190. At least one of these sensors may be provided in an external device (for example, the extension device 400).

The storage 140 includes at least one memory that stores programs and data. The storage 140 is also used as a work area to temporarily store the processing results of the controller 190. The storage 140 may include any non-transitory storage medium, such as a semiconductor storage medium, a magnetic storage medium or the like. The storage 140 may include a plurality of types of storage media. The storage 140 may include a combination of a portable storage medium, such as a memory card, an optical disk, a magneto-optical disk or the like, and a storage medium reader. The storage 140 may include a storage device used as a temporary storage area, such as RAM (Random Access Memory).

The communication interface 150 performs communication wirelessly. The communication interface 150 includes a cellular interface 151 and a WLAN interface 152. The cellular interface 151 complies, for example, with the 5G cellular communication standard. The WLAN interface 152 complies, for example, with the IEEE 802.11 standard.

A SIM (or a UIM (User Identity Module)) is attached to the SIM interface 160. The SIM interface 160 may be configured to attach the SIM thereto and detach the SIM therefrom. When receiving a request to read or write information from the controller 190, the SIM interface 160 reads information recorded in the SIM and writes information to the SIM. The SIM may be an eSIM (Embedded SIM). The SIM may be provided by a communication carrier or obtained by other means.

In an embodiment, a SIM for the public cellular communication network 210 and a SIM for the local cellular communication network 220 may be prepared separately. In a case where a SIM for the public cellular communication network 210 is used, the controller 190 uses the public cellular communication network 210 as a home network and uses the local cellular communication network 220 as a roaming network. On the other hand, in a case where a SIM for the local cellular communication network 220 is used, the controller 190 uses the local cellular communication network 220 as the home network and the public cellular communication network 210 as the roaming network. Alternatively, both the SIM for the public cellular communication network 210 and the SIM for the local cellular communication network 220 can be attached to the SIM interface 160.

The connection interface 170 is an interface electrically connected to the extension device 400. The connection interface 170 can be any interface electrically connected to the extension device 400, and can be for example, a USB interface.

The battery 180 stores electrical power to drive the electronic device. The battery 180 can be any type of secondary battery, for example, a lithium-ion battery.

The controller 190 is an arithmetic processing unit. The arithmetic processing unit includes, but are not limited to, for example, a CPU (Central Processing Unit), a SoC (System-on-Chip), an MCU (Micro Control Unit), a FPGA (Field-Programmable Gate Array), and a coprocessor. The controller 190 includes a GPU (Graphics Processing Unit), a VRAM (Video RAM) and the like, and draws various kinds of images on the display 112. The controller 190 may include a plurality of arithmetic processing units, and may perform various types of control through the cooperation of the plurality of arithmetic processing units.

The controller 190 comprehensively controls the operation of the electronic device 100 to achieve various functions. The controller 190 executes various controls based on operation input detected by the touch panel 111 and/or the physical button 113. The controller 190 may perform output corresponding to the operation signal input thereto by means of the voice output unit 122, the display 112, or the like.

### [Operation of Electronic Device]

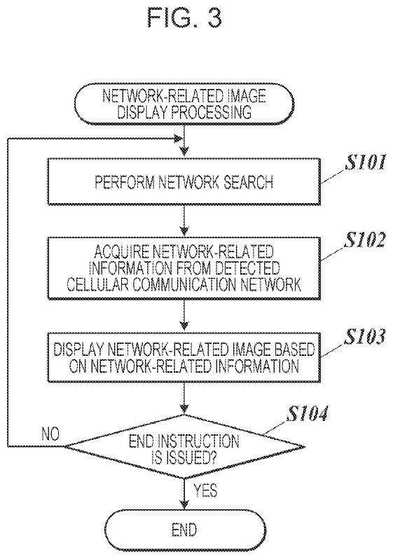

In an embodiment, the operation of the electronic device 100 is described. FIG. 3 is a flowchart illustrating a control procedure performed by the controller 190 in network-related image display processing according to an aspect of the present disclosure.

When the network-related image display processing illustrated in FIG. 3 is started, the controller 190 controls the cellular interface 151 to perform a network search (step S101). The network search refers to operation of detecting connectable cellular communication networks. For example, the cellular interface 151 attempts to receive a radio signal (for example, a synchronization or a reference signal) transmitted by the base station of each cellular communication network (i.e., the public cellular communication network 210 or the local cellular communication network 220). The controller 190 measures received power of the radio signal, and if the received power exceeds a threshold value, the controller 190 determines that the electronic device can be connected to the cellular communication network corresponding to the received power. Hereafter, the cellular communication network detected by the network search is referred to as a “detected cellular communication network”.

There are three patterns of the detected cellular communication network: (1) only the public cellular communication network 210, (2) only the local cellular communication network 220, and (3) both the public cellular communication network 210 and the local cellular communication network 220. In the following description, the pattern where the detected cellular communication network is only the public cellular communication network 210 or the pattern where detected cellular communication network is only the local cellular communication network 220 is mainly described, but the detected cellular communication network may be both the public cellular communication network 210 and the local cellular communication network 220.

Next, the controller 190 acquires network-related information from the detected cellular communication network via the cellular interface 151 (step S102). The network-related information includes, for example, the following information (a) to (c).

### (a) Network Identifier

A network identifier is an identifier that identifies the detected cellular communication network.

### (b) Information Indicating a Provided Service Type

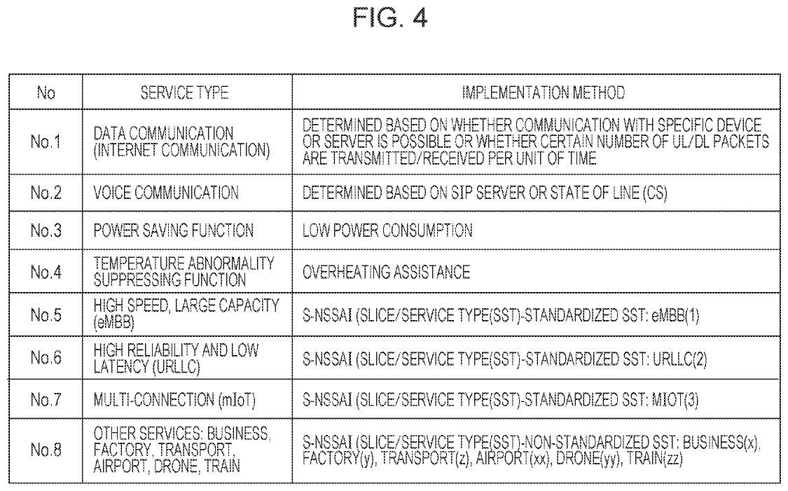

The provided service type is a type of service to be provided by the detected cellular communication network to the electronic device 100. As described above, each of the public cellular communication network 210 and the local cellular communication network 220 is theoretically divided into a plurality of slices corresponding to different service types (see FIG. 4). Each slice is assigned an identifier called S-NSSAI. The controller 190 acquires the S-NSSAI of each slice of the detected cellular communication network as information indicating the provided service type of the detected cellular communication network. The controller 190 may also acquire information other than S-NSSAI as the information indicating the provided service type.

### (c) Information Indicating a Network Type

The network type is a type indicating whether the detected cellular communication network is the public cellular communication network 210 or the local cellular communication network 220.

The controller 190 may also acquire the received power measured during the network search in step S101 as the network-related information.

Next, the controller 190 displays, on the display 112, a network-related image indicating predetermined information about the detected cellular communication network, based on the network-related information acquired in step S102 (step S103).

Next, the controller 190 determines whether an instruction to terminate the display operation by the electronic device 100 is issued (step S104).

If the controller 190 determines in step S104 that an instruction to terminate the display operation by the electronic device 100 is not issued (step S104; NO), the controller 190 returns the process to step S101 and repeats the process thereafter.

While if the controller 190 determines in step S104 that an instruction to terminate the display operation by the electronic device 100 is issued (step S104; YES), the controller 190 terminates the network-related image display processing.

The following describes specific display modes when the display control of the network-related image in step S103 is performed.

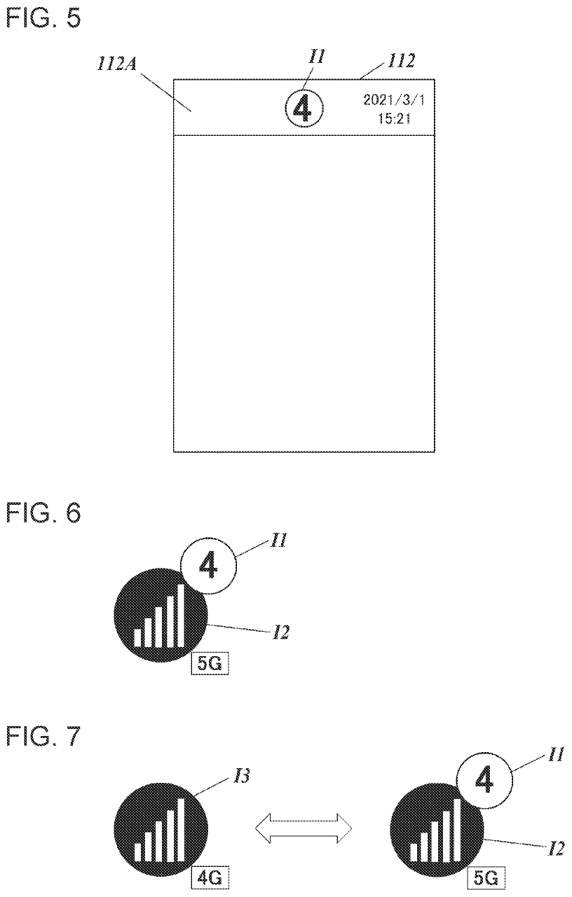

As one display mode, for example, as illustrated in FIG. 5, the controller 190 displays, as a network-related image, an image (for example, an image with a circled number) I1 that indicates the number of slices (for example, 4) of the detected cellular communication network in an upper portion 112A (so-called PICT area) of the display 112.

As illustrated in FIG. 6, the controller 190 may display the image I1 indicating the number of slices of the detected cellular communication network together with an image I2 that indicates the quality of communication with the detected cellular communication network. At this time, for example, when a predetermined operation is performed to switch between the 4G communication mode and the 5G communication mode, the network-related image is switched to display either a network-related image I3, which corresponds to 4G (slice non-corresponding communication network), or the network-related images I1 and I2, which correspond to 5G (slice corresponding communication network), as illustrated in FIG. 7.

Note that the controller 190 may display the image I1 and the image I2 so that the image I1 is superimposed on the image I2 (for example, FIG. 6), or display the image I1 and the image I2 so that the image I1 and the image I2 are separated from each other, or display the image I1 and the image I2 so that the image I2 is superimposed on the image I1.

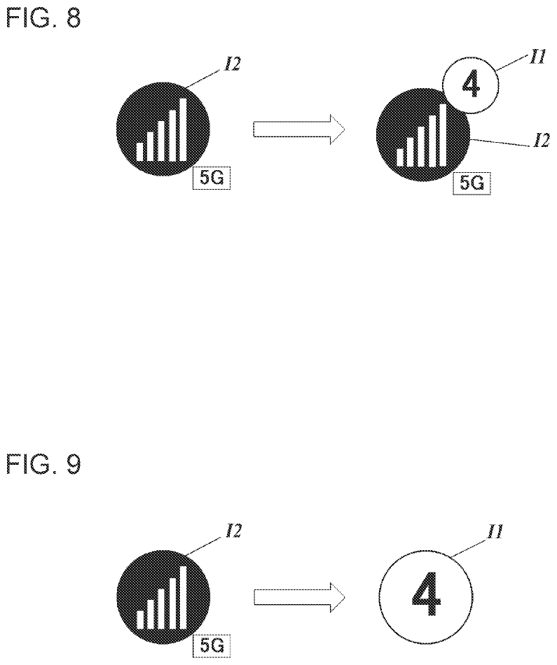

As illustrated in FIG. 8, the controller 190 may normally display only the image I2 indicating the quality of communication with the detected cellular communication network, and when a predetermined operation is performed via the touch panel 111, the image I1 indicating the number of slices of the detected cellular communication network may be displayed together with the image I2. Note that the above-described predetermined operation is not limited to the predetermined operation via the touch panel 111, but may also be a predetermined operation performed via the physical button 113 or the voice input unit 121.

As illustrated in FIG. 9, the controller 190 may normally display only the image I2 indicating the quality of communication with the detected cellular communication network, and when a predetermined operation corresponding to the image I2 is performed, the controller 190 may display the image I1 indicating the number of slices of the detected cellular communication network. Here, the predetermined operation corresponding to the image I2 is, for example, a touch operation performed on the image I2 via the touch panel 111, a cursor designation operation performed on the image I2 via the physical button 113, a predetermined voice operation performed via the voice input unit 121, or the like. After displaying the image I1 indicating the number of slices of the detected cellular communication network, the display may be returned to the image I2 when a predetermined time has elapsed (or when a predetermined operation is performed). Note that the image normally displayed is not limited to the image I2, which indicates the quality of communication with the detected cellular communication network, but may be, for example, an application icon that uses a slice corresponding to a type of service provided by the detected cellular communication network.

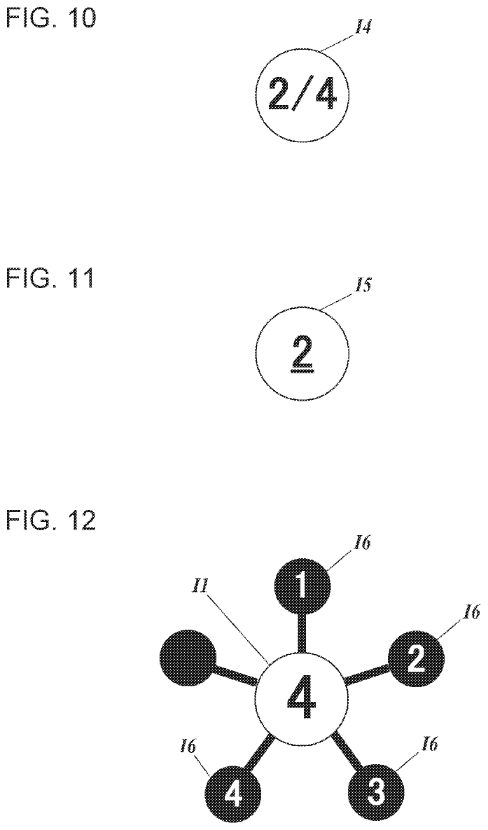

As illustrated in FIG. 10, the controller 190 may also display, as a network-related image, an image I4 that indicates, among the number of slices (for example, 4) in the detected cellular communication network, the number of slices (for example, 2/4) satisfying a predetermined condition. The number of slices satisfying the predetermined condition is, for example, number of slices that have been used before by the electronic device 100. The number of slices satisfying the predetermined condition may also be others such as, for example, number of slices that satisfies a predetermined communication amount or communication frequency, or number of slices that satisfies a predetermined quality of communication. The image indicating the number of slices that satisfy the predetermined condition among the number of slices of the detected cellular communication network is not limited to the image I4 illustrated in FIG. 10, but may be, as illustrated in FIG. 11, an image I5 in which the number of slices that satisfy the predetermined condition (for example, 2) is underlined for the purpose of being distinguished from the number of slices of the detected cellular communication network.

As illustrated in FIG. 12, the controller 190 may display, as a network-related image, the image I1 indicating the number of slices of the detected cellular communication network (for example, 4), and display images I6 around the image I1, the images I6 each indicating a service type provided by the detected cellular communication network to the electronic device 100. The image I6, which indicates the service type, displays the number corresponding to the service type (see FIG. 4). Based on a predetermined operation corresponding to the image I6, on/off control of the use of communication via the slice corresponding to the service type can be performed. The display content of the image I6 indicating the service type may be any content capable of identifying the service type; for example, the display content of the image I6 may be the identifier (S-NSSAI) of the corresponding slice or an icon set for the service type.

Here, when displaying the images I6, each indicating a service type provided by the detected cellular communication network to the electronic device 100, around the image I1, as described above, the controller 190 specifies, based on the information indicating the provided service types acquired in step S102 of the network-related image display processing (see FIG. 3), the provided service types from the candidates of the following service types of No. 1 to No. 8, as illustrated in FIG. 4. When a plurality of cellular communication networks is detected, the controller 190 specifies the provided service types for each detected cellular communication network.

### No. 1: Data Communication (Internet Communication)

The controller 190 determines whether communication with a specific device or server via the detected cellular communication network is possible, or whether a certain number of UL/DL packets are transmitted/received via the detected cellular communication network per unit of time. If the controller 190 determines that communication with a specific device or server via the detected cellular communication network is possible, the controller 190 specifies data communication as one of the provided service types of the detected cellular communication network. Alternatively, if the controller 190 determines that a certain number of uplink/downlink packets are transmitted and received via the detected cellular communication network per unit of time, the controller 190 specifies data communication as one of the provided service types of the detected cellular communication network.

### No. 2: Voice Communication

The controller 190 determines whether communication with a SIP server via the detected cellular communication network is possible or whether a line (CS) of the detected cellular communication network is available. If the controller 190 determines that communication with the SIP server via the detected cellular communication network is possible, the controller 190 specifies voice communication as one of the provided service types of the detected cellular communication network. Alternatively, if the controller 190 determines that the line (CS) of the detected cellular communication network is available, the controller 190 specifies voice communication as one of the provided service types of the detected cellular communication network.

### No. 3: Power Saving Function (Low Power Consumption)

The controller 190 determines whether a power saving function has been set for the electronic device 100 from the detected cellular communication network. The power saving function is set for the electronic device 100 by, for example, an RRC Reconfiguration message, which is one type of RRC message. If the controller 190 determines that the power saving function has been set for the electronic device 100 from the detected cellular communication network, the controller 190 specifies the power saving function as one of the provided service types of the detected cellular communication network.

### No. 4: Temperature Abnormality Suppressing Function (Overheating Assistance)

The controller 190 determines whether a temperature abnormality suppressing function has been set for the electronic device 100 from the detected cellular communication network. The temperature abnormality suppressing function is set for the electronic device 100 by, for example, an RRC Reconfiguration message, which is one type of RRC message. If the controller 190 determines that the temperature abnormality suppressing function has been set for the electronic device 100 from the detected cellular communication network, the controller 190 specifies the temperature abnormality suppressing function as one of the provided service types of the detected cellular communication network.

No. 5: High Speed, Large Capacity (eMBB)

The controller 190 determines whether a slice/service type (SST) of the S-NSSAI acquired from the detected cellular communication network includes a value “1” assigned to eMBB in the standard. The S-NSSAI is notified to the electronic device 100 by, for example, a Registration Accept message, which is one type of NAS (Non-Access Stratum) message. If the SST of the SNSSAI acquired from the detected cellular communication network includes the value “1” assigned to eMBB in the standard, the controller 190 specifies eMBB as one of the provided service types of the detected cellular communication network.

### No. 6: High Reliability and Low Latency (URLLC)

The controller 190 determines whether the SST of the S-NSSAI acquired from the detected cellular communication network includes a value “2” assigned to URLLC in the standard. If the SST of the S-NSSAI acquired from the detected cellular communication network includes the value “2” assigned to URLLC in the standard, the controller 190 specifies URLLC as one of the provided service types of the detected cellular communication network.

No. 7: Multi-Connection (mIoT)

The controller 190 determines whether the SST of the S-NSSAI acquired from the detected cellular communication network includes a value “2” assigned to mIoT in the standard. If the SST of the S-NSSAI acquired from the detected cellular communication network includes the value “2” assigned to mIoT in the standard, the controller 190 specifies mIoT as one of the provided service types of the detected cellular communication network.

### No. 8: Other Services

The controller 190 determines whether the SST of the S-NSSAI acquired from the detected cellular communication network includes a value assigned to each type of service in proprietary specifications. For example, an SST “x” is assigned to Business, an SST “y” is assigned to Factory, an SST “z” is assigned to Transport, an SST “xx” is assigned to Airport, an SST “yy” is assigned to Drone, and an SST “zz” is assigned to Train. If the SST of the S-NSSAI acquired from the detected cellular communication network includes a value assigned in a proprietary specification, the controller 190 specifies the service type corresponding to such value as the provided service type of the detected cellular communication network.

As illustrated in FIG. 6, the controller 190 normally displays the image I2 indicating the quality of communication with the detected cellular communication network together with the image I1 indicating the number of slices of the detected cellular communication network (for example, 4). When a predetermined operation corresponding to the image I1 is performed, as illustrated in FIG. 12, the images I6, each indicating a service type provided by the detected cellular communication network to the electronic device 100, may be displayed around the image I1 with the image I1 as the center. Here, the predetermined operation corresponding to the image I1 is, for example, a touch operation performed on the image I1 via the touch panel 111, a cursor designation operation performed on the image I1 via the physical button 113, a predetermined voice operation performed via the voice input unit 121, or the like.

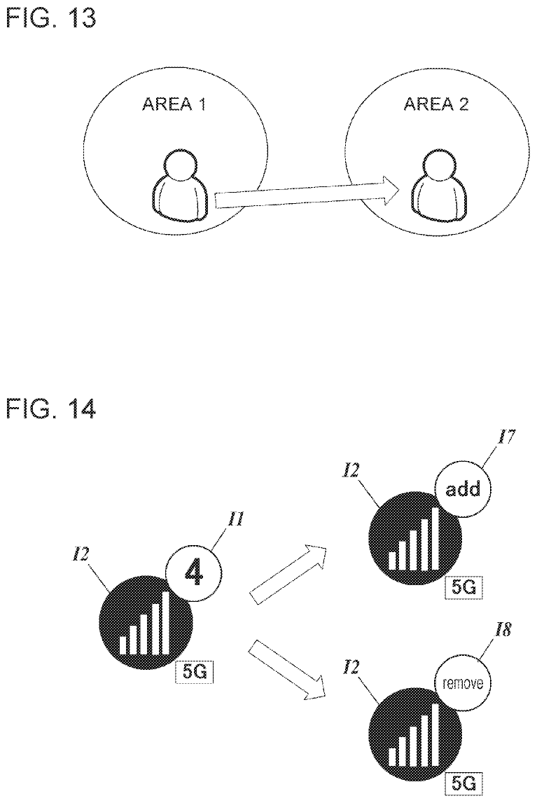

As illustrated in FIG. 13, when the user moves from Area 1 to Area 2, the controller 190 may determine whether the number of slices of the detected cellular communication network is changed, based on the network-related information acquired in step S102 of the network-related image display processing (see FIG. 3), and if the number of slices is changed, such change is notified. Specifically, as illustrated in FIG. 14, for example, if the number of slices of the detected cellular communication network increases from 4 to 5 when the user moves from Area 1 to Area 2, the controller 190 displays an image (for example, an image expressed by circled letters “add”) 17 indicating that the number of slices of the detected cellular communication network has increased. On the other hand, if the number of slices of the detected cellular communication network decreases from 4 to, for example, 3 when the user moves from Area 1 to Area 2, the controller 190 displays an image (for example, an image expressed by circled letters “remove”) 18 indicating that the number of slices of the detected cellular communication network has decreased.

When the number of slices of the detected cellular communication network increases, the controller 190 may change the display color of the image I2 indicating the quality of communication with the detected cellular communication network to a preset display color (for example, red) or change the display mode to a preset display mode (for example, blinking display at a high speed) to thereby notify that the number of slices of the detected cellular communication network has increased. On the other hand, when the number of slices of the detected cellular communication network decreases, the controller 190 may change the display color of the image I2 indicating the quality of communication with the detected cellular communication network to a preset display color (for example, blue) or change the display mode to a preset display mode (for example, blinking display at a low-speed) to thereby notify that the number of slices of the detected cellular communication network has decreased. The method of notification regarding the increase or decrease in the number of slices of the detected cellular communication network is not limited to the methods described above. For example, a voice or the like may be output from the voice output unit 122 to notify that the number of slices of the detected cellular communication network has increased or decreased. The controller 190 may notify that the number of slices of the detected cellular communication network has increased or decreased by emitting light from a light emitter (not illustrated) provided in the electronic device 100. The controller 190 may also notify that the number of slices of the detected cellular communication network has increased or decreased by activating a vibration function provided in the electronic device 100.

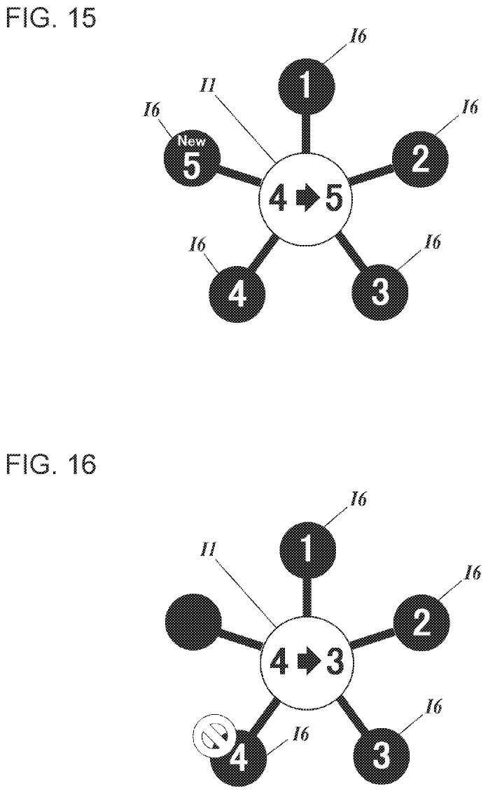

When performing a predetermined operation corresponding to the image I7 (see FIG. 14) indicating that the number of slices of the detected cellular communication network has increased, the controller 190 may, as illustrated in FIG. 15, display the images I6, each indicating a service type provided by the detected cellular communication network to the electronic device 100, around the image I1 indicating the number of slices (for example, 4⇒5) of the detected cellular communication network with the image I1 as the center. At this time, a word “New” is displayed in the image I6 that indicates the service type corresponding to the newly available slice (for example, the service type of No. 5). Here, the image I6 is displayed to make it easier for the user to notice which service type corresponds to the newly available slice. The controller 190 may, for example, make it easier for the user to notice the newly available slice by changing the display mode of the image indicating the service type corresponding to the newly available slice (changing the display mode means, for example, making the image indicating the service type corresponding to the newly available slice blink at a preset first speed, changing the color of the image to a preset first color, moving the display position of the image to a preset first position, or the like). On the other hand, when performing a predetermined operation corresponding to the image I8 (see FIG. 14) indicating that the number of slices of the detected cellular communication network has decreased, the controller 190 may, as illustrated in FIG. 16, display the images I6, each indicating a service type provided by the detected cellular communication network to the electronic device 100, around the image I1 indicating the number of slices (for example, 4⇒3) of the detected cellular communication network with the image I1 as the center. At this time, a pattern indicating unavailable is displayed on the image I6, which indicates the service type corresponding to the slice that is unusable (for example, the service type of No. 4). Here, the image I6 is displayed to make it easier for the user to notice which service type corresponds to the unusable slice. The controller 190 may, for example, make it easier for the user to notice the unusable slice by changing the display mode of the image indicating the service type corresponding to the unusable slice (changing the display mode means, for example, making the image indicating the service type corresponding to the unusable slice blink at a preset second speed, changing the color of the image to a preset second color, moving the display position of the image to a preset second position, or the like).

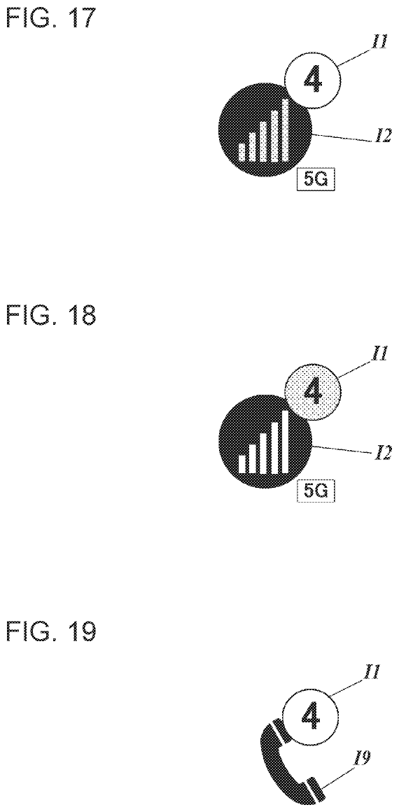

The controller 190 may determine, based on the network-related information acquired in step S102 of the network-related image display processing (see FIG. 3), whether the detected cellular communication network includes a predetermined service type, and if the detected cellular communication network includes the predetermined service type, such inclusion is notified. Specifically, the controller 190 determines, based on the above-described network-related information, whether a service type (for example, voice communication (No. 2) and high reliability and low latency (No. 6); see FIG. 4) that is uniquely recommended for the electronic device 100 is included in the detected cellular communication network. If such a service type is included, the controller 190 may change the display color of the meter portion of the image I2 indicating the quality of communication with the detected cellular communication network to a preset display color (for example, purple) to thereby notify that the service type that is uniquely recommended for the electronic device 100 is included in the detected cellular communication network, as illustrated in FIG. 17. Here, it is assumed that the service types uniquely recommended for the electronic device 100 have been set in advance, and the recommended service types are stored in the storage 140. As illustrated in FIG. 18, the display color of the image I1, which indicates the number of slices of the detected cellular communication network, may be changed to a preset display color (for example, yellow) to notify that the service types uniquely recommended for the electronic device 100 are included in the detected cellular communication network.

Based on the above-described network-related information, the controller 190 determines whether a service type (for example, voice communication (No. 2); see FIG. 4) uniquely recommended for an application (for example, a call application) executed in the electronic device 100 is included in the detected cellular communication network. If such a service type is included, when such an application is being executed or when an operation is performed to specify an icon for such an application, the controller 190 displays, together with an image I9 indicating such an application, the image I1 indicating the number of slices of the detected cellular communication network on the display 112, as illustrated in FIG. 19, to thereby notify that the service type uniquely recommended for such an application is included in the detected cellular communication network. Here, it is assumed that the service type uniquely recommended for the application executed in the electronic device 100 has been set in advance, and the recommended service type is stored in the storage 140.

The method of notifying that a service type uniquely recommended for the electronic device 100 is included in the detected cellular communication network, and the method of notifying that a service type uniquely recommended for the application executed in the electronic device 100 is included in the detected cellular communication network are not limited to the methods described above. For example, the voice output unit 122 may output a voice indicating that a service type uniquely recommended for the electronic device 100 is included in the detected cellular communication network, or a voice indicating that a service type uniquely recommended for the application executed on the electronic device 100 is included in the detected cellular communication network. The controller 190 may notify, by emitting light from a light emitter (not illustrated) provided in the electronic device 100 or by activating a vibration function provided in the electronic device 100, that a service type uniquely recommended for the electronic device 100 is included in the detected cellular communication network or that a service type uniquely recommended for the application executed by the electronic device 100 is included in the detected cellular communication network.

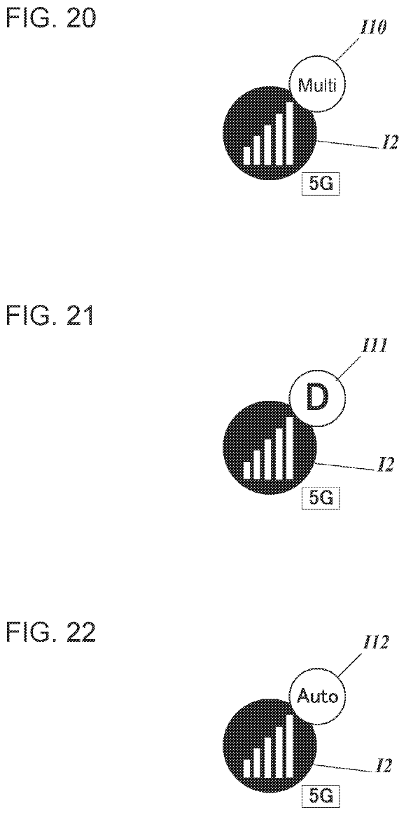

As illustrated in FIGS. 20 to 22, the controller 190 may also display, as network-related images, images I10 to I12 that indicate features of the detected cellular communication network. Specifically, as illustrated in FIG. 20, when the service types included in the detected cellular communication network are only multi-connection (mIoT) (No. 7) (or when many service types specialized in multi-connection are included), the controller 190 displays, together with the image I2 indicating the quality of communication with the detected cellular communication network, the image (for example, an image expressed by circled letters “multi”) I10 indicating that the service types of the detected cellular communication network include multi-connection (mIoT). Further, as illustrated in FIG. 21, when the service types included in the detected cellular communication network are only Drone (No. 8) (or when many service types specialized in Drone are included), the controller 190 displays, together with the image I2 indicating the quality of communication with the detected cellular communication network, the image (for example, an image expressed by circled letter “D”) I11 indicating that the service types of the detected cellular communication network include Drone. Further, as illustrated in FIG. 22, when the service types included in the detected cellular communication network are only high reliability and low latency (URLLC) (No. 6), which is most suitable for automatic driving communication and the like (or when many service types specialized in high reliability and low latency are included), the controller 190 displays, together with the image I2 indicating the quality of communication with the detected cellular communication network, the image (for example, an image expressed by circled letters “Auto”) 112 indicating that the service types of the detected cellular communication network include high reliability and low latency.

Note that the controller 190 may, for example, change the display color of the image I2 or change the display mode to indicate the feature of the detected cellular communication network. For example, the controller 190 may indicate that the higher the blinking speed of the image I2 becomes, the more service types specialized in high reliability and low latency is included in the detected cellular communication network.

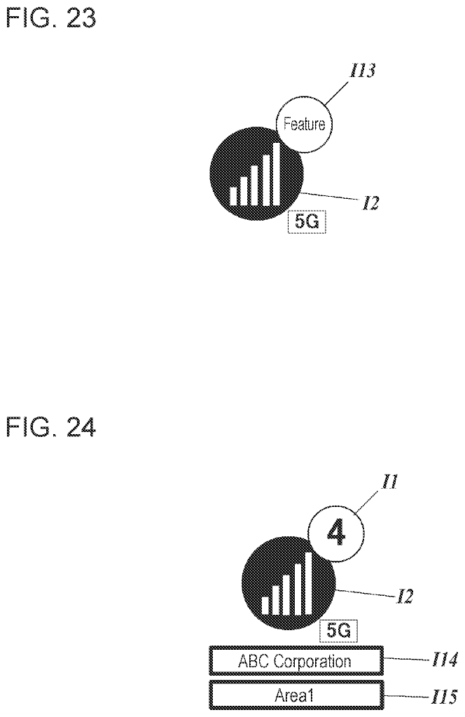

Further, for example, among the service types No. 1 to No. 8 illustrated in FIG. 4, when service types No. 1 and No. 2 are classified as Class 1 and service types No. 3 to No. 8 are classified as Class 2 (feature set) and when the service types included in the detected cellular communication network are only service types belonging to Class 2, the controller 190 may display, together with the image I2 indicating the quality of communication with the detected cellular communication network, an image (for example, an image expressed by circled letters “feature”) I13 indicating that the service types of the detected cellular communication network correspond to Class 2 (feature set) as illustrated in FIG. 23.

Further, as illustrated in FIG. 24, when the detected cellular communication network is the local cellular communication network 220, the controller 190 may acquires, via the cellular interface 151, owner information indicating the owner (for example, ABC Corporation) of the license corresponding to the local cellular communication network 220 and communication area information indicating the communication area of the local cellular communication network 220 (for example, Area 1), and display, based on the acquired owner information and communication area information, an image I14 indicating the owner and an image I15 indicating the communication area, together with the image I1 indicating the number of slices of the detected cellular communication network and the image I2 indicating the quality of communication with the detected cellular communication network.

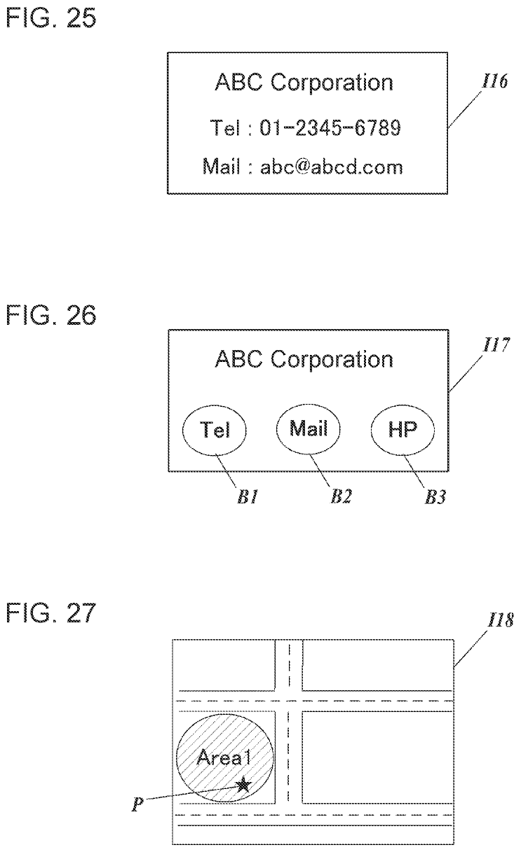

When a predetermined operation (for example, a touch operation) is performed on the image I14 indicating the owner described above, as illustrated in FIG. 25, the controller 190 may display, on the display 112, a guide image I16 indicating the telephone number and e-mail address of ABC Corporation, which is the owner. Instead of the guide image I16, the controller 190 may display on the display 112 a guide image I17 with, for example, a Tel button B1 to call the telephone number of ABC Corporation, a Mail button B2 to send an e-mail to the e-mail address of ABC Corporation, and a LINK button B3 to access the website of ABC Corporation, as illustrated in FIG. 26.

When a predetermined operation (for example, a touch operation) is performed on the image I15 indicating the communication area described above, the controller 190 may display a map image I18 indicating Area 1, which is the communication area, on the display 112, as illustrated in FIG. 27. The controller 190 may also display the user's current position P when displaying the map image I18.

### [Variation 1]

An electronic device 100A of Variation 1 is described. The electronic device 100A differs from the above embodiment in that the electronic device 100A intends to be a wearable terminal device. In the following description, the differences from the above embodiment are described, and points common to the above embodiment are omitted.

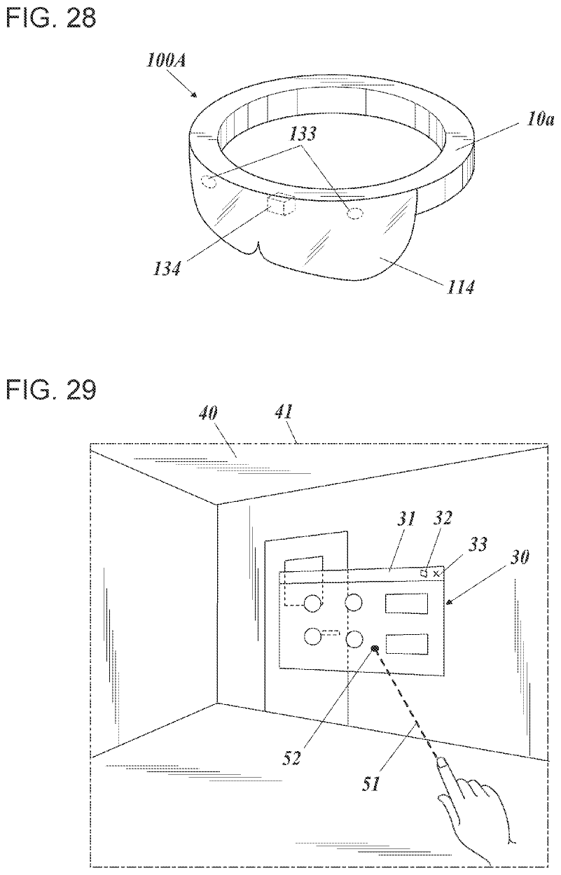

As illustrated in FIG. 28, the electronic device 100A includes a main body portion 10a and a visor 114 (display member) attached to the main body portion 10a.

The main body portion 10a is an annular member whose circumference can be adjusted. Various devices, such as a depth sensor 133, a camera 134 and the like, are built into the main body portion 10a. When the main body portion 10a is worn on the head of a user, the user's field of vision is covered by the visor 114.

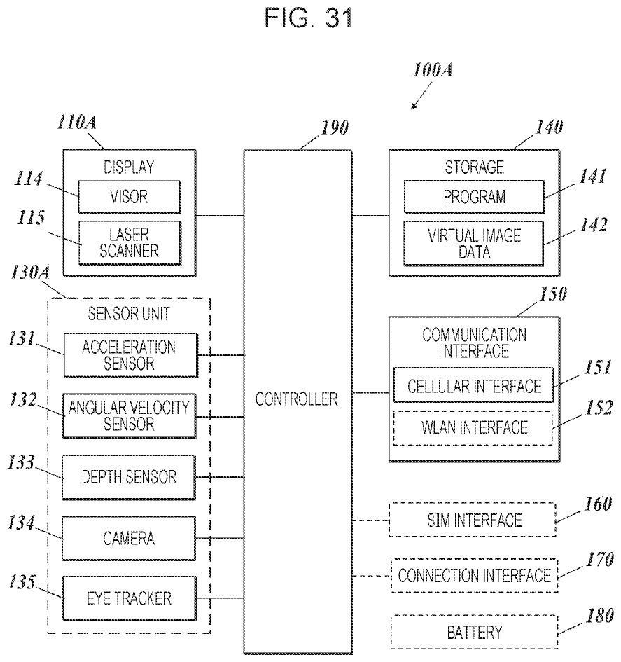

The visor 114 has light transmissivity. The user can view the real space through the visor 114. On a display surface of the visor 114 that faces the eyes of the user, an image, such as a virtual image, is projected and displayed from a laser scanner 115 (see FIG. 31) built into the main body portion 10a. The user views the virtual image formed by reflected light from the display surface. At this time, since the user also views the real space through the visor 114, a visual effect as if the virtual image exists in the real space is obtained

As illustrated in FIG. 29, while a virtual image 30 is displayed, the user views the virtual image 30 facing in a predetermined direction at a predetermined position in a space 40. In the present variation, the space 40 is the real space that the user views through the visor 114. Since the virtual image 30 is projected onto the visor 114 having light transmissivity, the virtual image 30 is viewed as a translucent image superimposed on the real space. In FIG. 29, a flat window screen is illustrated as an example of the virtual image 30, but the virtual image 30 is not limited to such an example and may be, for example, various types of stereoscopic images. In a case where the virtual image 30 is a window screen, the virtual image 30 has a front surface and a back surface. Necessary information is displayed on the front surface, and usually no information is displayed on the back surface.

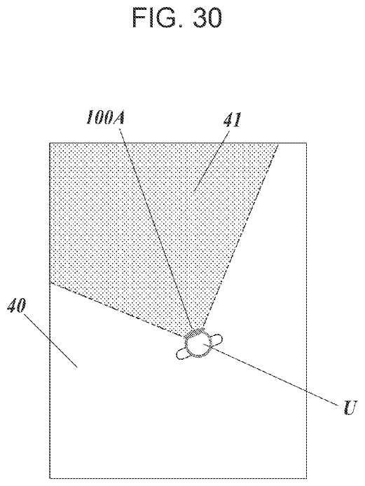

The electronic device 100A detects a viewing area 41 of the user based on the position and orientation of the user (in other words, the position and orientation of the electronic device 100A) in the space 40. As illustrated in FIG. 30, the viewing area 41 is an area of the space 40 located in front of a user U who wears the electronic device 100A. For example, the viewing area 41 is an area within a predetermined angular range from the front of the user U to the left-right direction and up-down direction. In this case, when a three-dimensional object corresponding to the shape of the viewing area 41 is cut in a plane perpendicular to the front direction of the user U, the shape of the cutout is rectangular. Note that the shape of the viewing area 41 may also be defined so that the shape of the cutout is a shape other than rectangular (for example, circular, oval or the like). The shape of the viewing area 41 (for example, an angular range from the front to the left-right direction and up-down direction) can be specified, for example, by the following methods.

In the electronic device 100A, the field of view is adjusted (hereinafter referred to as “calibration”) in a predetermined procedure at a predetermined timing, such as when the electronic device 100A is first started up. The calibration specifies an area visible to the user, and the virtual image 30 is displayed within such an area thereafter. The shape of the visible area specified by the calibration can be the shape of the viewing area 41.

Calibration is not limited to the above-described predetermined procedure, but may be performed automatically during normal operation of the electronic device 100A. For example, the field of view (and the shape of the viewing area 41) may be adjusted by displaying an indication to which the user is expected to respond, and if the user does not respond to such an indication, the area in which the indication is displayed is considered to be an area outside the user's field of view. The field of view (and the shape of the viewing area 41) may also be adjusted by displaying a test indication at a position determined to be outside the range of the field of view, and if the user responds to such an indication, the area in which the indication is displayed is considered to be an area within the range of the user's field of view.

Note that the shape of the viewing area 41 may be preset and fixed at the time of shipment or the like, not based on the result of the field of view adjustment. For example, the shape of the viewing area 41 may be defined as the maximum displayable area on the optical design of a display 110A.

The virtual image 30 is generated in response to a predetermined operation made by the user, while the display position and orientation in the space 40 are determined. The electronic device 100A projects and displays, among the generated virtual images 30, the virtual image 30 whose display position is determined within the viewing area 41 onto the visor 114. In FIG. 29, the viewing area 41 is indicated by a chain line.

The display position and orientation of the virtual image 30 in the visor 114 is updated in real time in response to the change of the user's viewing area 41. In other words, the display position and orientation of the virtual image 30 changes in response to the change of the viewing area 41 so that the user recognizes that “the virtual image 30 is located within the space 40 at set position and orientation. For example, when the user moves from the front side to the back side of the virtual image 30, the shape (angle) of the displayed virtual image 30 gradually changes in response to such movement. When the user turns around to the back side of the virtual image 30 and then faces in the direction of the virtual image 30, the back surface of the virtual image 30 is displayed so that the user can view the back surface of the virtual image 30. In response to the change of the viewing area 41, the virtual image 30 whose display position is outside the viewing area 41 is no longer displayed, and if there is a virtual image 30 whose display position falls within the viewing area 41, such a virtual image 30 is newly displayed.

As illustrated in FIG. 29, when the user holds his or her hand (or finger) forward, the direction in which the hand is extended is detected by the electronic device 100A, and a virtual line 51 extending in that direction and a pointer 52 are displayed on the display surface of the visor 114 to be viewed by the user. The pointer 52 is displayed at the intersection of the virtual line 51 and the virtual image 30. If the virtual line 51 does not intersect with the virtual image 30, the pointer 52 may be displayed at the intersection of the virtual line 51 and the wall surface or the like of the space 40. If the distance between the user's hand and the virtual image 30 is within a predetermined reference distance, the display of the virtual line 51 may be omitted and the pointer 52 may be directly displayed at a position corresponding to the position of the user's fingertip.

The user can adjust the direction of the virtual line 51 and the position of the pointer 52 by changing the direction in which the hand is extended. By performing a predetermined gesture with the pointer 52 adjusted to be positioned on a predetermined operation target (for example, a function bar 31, a window shape changing button 32, a close button 33 or the like) included in the virtual image 30, the gesture is detected by the electronic device 100A, so that a predetermined operation can be performed on the operation target. For example, by performing an operation target selection gesture (for example, a fingertip pinching gesture) with the pointer 52 aligned with the close button 33, the virtual image 30 can be closed (deleted). The virtual image 30 can be moved in the depth and left/right directions by making a gesture of selection with the pointer 52 aligned with the function bar 31, and making a gesture of moving the hand forward/backward and left/right while maintaining the selected state. Operations on the virtual image 30 are not limited to the examples described above.

Thus, the electronic device 100A of the present variation can realize a visual effect as if the virtual image 30 exists in the real space, and can receive the user's operation on the virtual image 30 and reflect the user's operation in the display of the virtual image 30. In other words, the electronic device 100A of the present variation provides MR (Mixed Reality).

A functional configuration of the electronic device 100A is described with reference to FIG. 31. The electronic device 100A includes the display 110A, a sensor unit 130A, a storage 140, a communication interface 150, a SIM interface 160, a connection interface 170, a battery 180, and a controller 190. Each of the components illustrated in FIG. 31, except for the visor 114 of the display 110A, is built into the main body portion 10a and is operated by power supplied from the battery 180, which is also built into the main body portion 10a.

The controller 190 performs various control operations by reading and executing a program 141 stored in the storage 140. The controller 190 executes the program 141 to perform, for example, viewing area detection processing and display control processing. The viewing area detection processing is the processing of detecting the user's viewing area 41 in the space 40. The display control processing is the processing of displaying, among the virtual images 30 whose positions in the space 40 are determined, the virtual image 30 whose position is determined within the viewing area 41, on the display 110A.

The storage 140 stores the program 141 to be executed by the controller 190 and various setting data. The program 141 is stored in the storage 140 in the form of computer-readable program code.

The data stored in the storage 140 includes virtual image data 142 relating to the virtual image 30. The virtual image data 142 includes data relating to the display content of the virtual image 30 (for example, image data), data of the display position of the virtual image 30, and data of the orientation of the virtual image 30.

The display 110A includes the visor 114, the laser scanner 115, and an optical system that guides light output from the laser scanner 115 to the display surface of the visor 114. The laser scanner 115 irradiates the optical system with a pulsed laser beam, the on/off of which is controlled for each pixel, according to a control signal from the controller 190, while scanning in a predetermined direction. The laser beam incident on the optical system forms a display screen consisting of a two-dimensional matrix of pixels on the display surface of the visor 114. The method of the laser scanner 115 is not particularly limited. For example, a method in which a laser beam is scanned by operating a mirror with a MEMS (Micro Electro Mechanical Systems) may be used as the method of the laser scanner 115. The laser scanner 115 includes three light emitters that emit laser beams in RGB colors, for example. The display 110A can perform color display by projecting light from these light emitters onto the visor 114.

The sensor unit 130A includes an acceleration sensor 131, an angular velocity sensor 132, the depth sensor 133, the camera 134, and an eye tracker 135. The sensor unit 130A may include other sensors not illustrated in FIG. 31.

The acceleration sensor 131 detects acceleration and outputs the detection result to the controller 190. The translational movement of the electronic device 100A in three orthogonal axes can be detected from the detection result output by the acceleration sensor 131.

The angular velocity sensor 132 (gyro sensor) detects angular rate and outputs the detection result to the controller 190. The rotational motion of the electronic device 100A can be detected from the detection result output by the angular velocity sensor 132.

The depth sensor 133 is an infrared camera that detects the distance to a subject using ToF (Time of Flight) method and outputs the detection result of the distance to the controller 190. The depth sensor 133 is disposed on the front surface of the main body portion 10a so that the viewing area 41 can be photographed. By repeating the measurement by the depth sensor 133 each time the position and orientation of the user changes in the space 40 and combining the results, a 3D mapping of the entire space 40 can be performed (i.e., a three-dimensional structure of the entire space 40 can be acquired).

The camera 134 uses an imaging element group of RGB to photograph the space 40, acquires color image data as the photographing result, and outputs the color image data to the controller 190. The camera 134 is disposed on the front surface of the main body portion 10a so that the viewing area 41 can be photographed. The image output from the camera 134 is used to detect the position, orientation and the like of the electronic device 100A, and is also transmitted from the communication interface 150 to an external device to display the user's viewing area 41 of the electronic device 100A on the external device.

The eye tracker 135 detects the line of sight of the user, and outputs the detection result to the controller 190. The method for detecting the line of sight is not particularly limited. For example, the method for detecting the line of sight may also use a method in which reflection points of near infrared light in the user's eyes are photographed by an eye tracking camera, and the photographing result and an image photographed by the camera 134 are analyzed to specify the object at which the user is looking. Some of the components of the eye tracker 135 may be provided on the periphery or the like of the visor 114.

In the electronic device 100A with such a configuration, the controller 190 performs the following control operations.

The controller 190 performs 3D mapping of the space 40 based on the data of the distance to the subject input from the depth sensor 133. The controller 190 repeats the 3D mapping whenever the position and orientation of the user changes, and updates the result each time. The controller 190 performs the 3D mapping with a series of spaces 40 as a unit. Therefore, when the user moves between a plurality of rooms divided by walls or the like, the controller 190 recognizes each room as a single space 40, and performs 3D mapping separately for each room.

The controller 190 detects the user's viewing area 41 in the space 40. To be specific, the controller 190 specifies the position and orientation of the user (the electronic device 100A) in the space 40, based on the detection results obtained by the acceleration sensor 131, the angular velocity sensor 132, the depth sensor 133, the camera 134 and the eye tracker 135, and accumulated results of the 3D mapping. The controller 190 detects (specifies) the viewing area 41 based on the specified position and orientation and the preset shape of the viewing area 41. The controller 190 continuously detects the position and orientation of the user in real time and updates the viewing area 41 in conjunction with the change in the position and orientation of the user. The detection of the viewing area 41 may be performed using the detection result obtained by some of the acceleration sensor 131, the angular velocity sensor 132, the depth sensor 133, the camera 134, and the eye tracker 135.

The controller 190 generates the virtual image data 142 relating to the virtual image 30 in response to the operation of the user. In other words, when detecting a predetermined operation (gesture) that instructs the generation of the virtual image 30, the controller 190 specifies the display content (for example, image data), the display position, and the orientation of the virtual image, and generates the virtual image data 142 that includes data representing the specified results.

The controller 190 displays the virtual image 30, the display position of which is determined within the viewing area 41, on the display 110A. The controller 190 specifies the virtual image 30 whose display position is determined within the viewing area 41 based on the information about the display position contained in the virtual image data 142, and generates, based on the positional relationship between the viewing area 41 at that time and the display position of the specified virtual image 30, the image data of the display screen to be displayed on the display 110A. The controller 190 causes the laser scanner 115 to perform a scanning operation based on the generated image data and to form the display screen containing the specified virtual image 30 on the display surface of the visor 114. In other words, the controller 190 causes the virtual image 30 to be displayed on the display surface of the visor 114 so that the virtual image 30 can be viewed in the space 40, which is visible through the visor 114. By continuously performing the display control processing, the controller 190 updates the display content displayed by the display 110A in real time in response to the movement of the user (the change of the viewing area 41). In a case where the electronic device 100A is set to retain the virtual image data 142 even after being turned off, when the electronic device 100A is turned on next time, the existing virtual image data 142 is read, and the virtual image 30 located within the viewing area 41, if any, is displayed on the display 110A.

Note that the virtual image data 142 may also be generated based on instruction data acquired from an external device via the communication interface 150, and the virtual image 30 may be displayed based on the generated virtual image data 142. Alternatively, the controller 190 may acquire the virtual image data 142 itself from an external device via the communication interface 150 and display the virtual image 30 based on the acquired virtual image data 142. For example, the controller 190 may cause the image of the camera 134 of the electronic device 100A to be displayed on an external device operated by a remote instructor, receive an instruction from the external device to display the virtual image 30, and display the instructed virtual image 30 on the display 110A of the electronic device 100A. Thus, for example, such operation of the remote instructor to instruct the user of the electronic device 100A to perform a work can be performed by displaying a virtual image 30 indicating a work content in the vicinity of a work object.

The controller 190 detects the position and orientation of the user's hand (and/or fingers) based on the images photographed by the depth sensor 133 and the camera 134, and displays the virtual line 51 extending in the detected direction and the pointer 52 on the display 110A. The controller 190 detects a gesture of the hand (and/or fingers) of the user based on the images photographed by the depth sensor 133 and the camera 134, and executes processing corresponding to the content of the detected gesture and the position of the pointer 52 at that time.

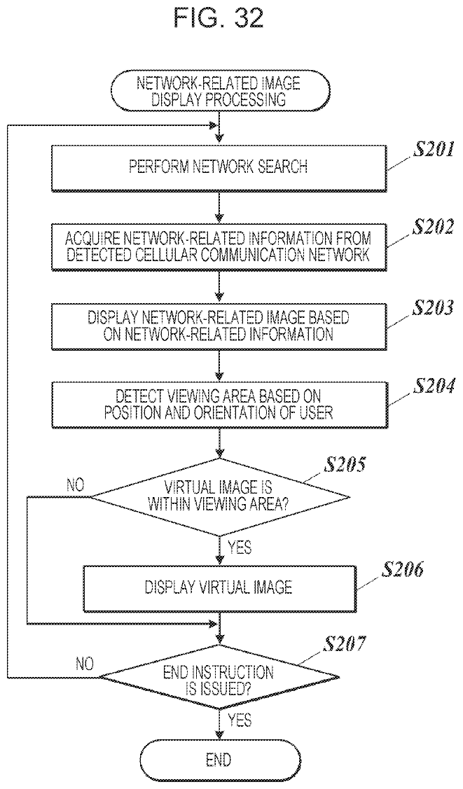

The operation of the electronic device 100A is described below. FIG. 32 is a flowchart illustrating a control procedure of the network-related image display processing performed by the electronic device 100A.

When the network-related image display processing illustrated in FIG. 32 is started, the controller 190 controls the cellular interface 151 to perform a network search (step S201).

Next, the controller 190 acquires the network-related information from the detected cellular communication network via the cellular interface 151 (step S202).

Next, the controller 190 displays, on the display 112, a network-related image indicating predetermined information about the detected cellular communication network based on the network-related information acquired in step S202 (step S203).

Next, the controller 190 detects the viewing area 41 based on the position and orientation of the user (step S204).

Next, the controller 190 determines whether there is a virtual image 30 whose display position is determined within the detected viewing area 41 (step S205).

If the controller 190 determines in step S205 that there is no virtual image 30 whose display position is determined within the detected viewing area 41 (step S205; NO), the controller 190 proceeds to step S207.

If the controller 190 determines in step S205 that there is a virtual image 30 whose display position is determined within the detected viewing area 41 (step S205; YES), the controller 190 displays the virtual image 30 on the display 110A (step S206).

Next, the controller 190 determines whether an instruction to terminate the display operation to be performed by the electronic device 100A is issued (step S207).

If the controller 190 determines in step S207 that an instruction to terminate the display operation to be performed by the electronic device 100A is not issued (step S207; NO), the controller 190 returns the process to step S201 and repeats the process thereafter.

If the controller 190 determines in step S207 that an instruction to terminate the display operation to be performed by the electronic device 100A is issued (step S207; YES), the controller 190 terminates the network-related image display processing.

The following describes the specific display mode when the display control of the network-related image in step S203 is performed and the display control of the virtual image 30 in step S206 is performed.

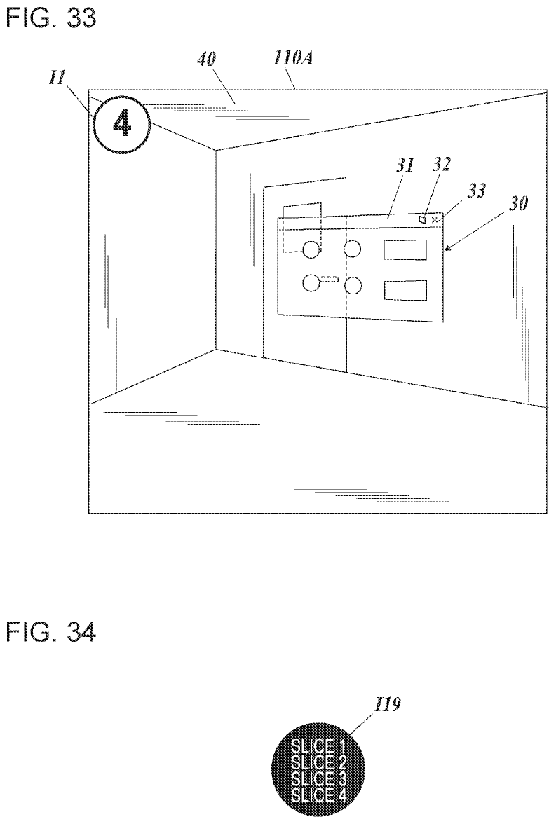

As one display mode, for example, as illustrated in FIG. 33, the controller 190 displays the virtual image 30 on the display 110A and displays, as a network-related image, an image I1 indicating the number of slices of the detected cellular communication network in an upper left portion of the display 110A. Specifically, the controller 190 displays the image I1 while the image I1 is fixed in the upper left portion of the display 110A so that the user and the image I1 always face each other. In other words, even if the user turns around to the back side of the virtual image 30 displayed on the display 110A, the image I1 is displayed in the upper left portion of the display 110A.

Similarly to the case of the electronic device 100 described above, the controller 190 may display the image I1 indicating the number of slices of the detected cellular communication network together with an image I2 indicating the quality of communication with the detected cellular communication network (see FIG. 6).

Note that the controller 190 may display, for example, in response to a predetermined operation performed by the user, an object, similar to the virtual image 30, that displays the image I1 indicating the number of slices of the detected cellular communication network while the display position and orientation of the object in the space 40 are determined. In such a case, the controller 190 displays the image I2 indicating the quality of communication with the detected cellular communication network on a surface (second surface) opposite a surface (first surface) of the above-described object on which the image I1 is displayed. The image displayed on the above-described second surface is not limited to the image I2 indicating the quality of communication with the detected cellular communication network, but may be, for example, an application icon using the slice corresponding to a type of service provided by the detected cellular communication network, or an image I19, as illustrated in FIG. 34, indicating service types (slices) capable of being provided by the detected cellular communication network. The controller 190 may be able to switch, in response to a predetermined operation made by the user (for example, an operation made by a gesture, an operation made using the physical button 113, a voice operation made using the voice input unit 121, or the like), between a first setting, in which the above-described object is displayed while the first surface or the second surface is fixed on the display 110A so that the first surface or the second surface always faces the user, and a second setting, in which the above-described object is displayed in a posture corresponding to an angle at which the user views the object.

### [Variation 2]

In Variation 2, a configuration of a display system 1 is described. Variation 2 differs from Variation 1 in that an external information processing device 20 executes part of the processing that is executed by the controller 190 of the electronic device 100A in Variation 1. In the following description, the differences from Variation 1 are described, the points common to Variation 1 are omitted.

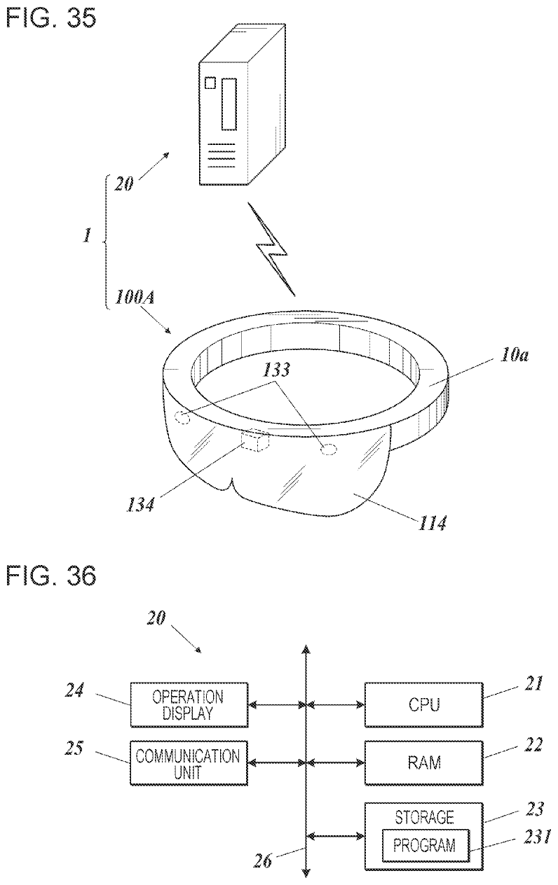

As illustrated in FIG. 35, the display system 1 includes an electronic device 100A and the information processing device 20 (server) communicably connected to the electronic device 100A. At least a part of the communication path between the electronic device 100A and the information processing device 20 may be realized by wireless communication. The hardware configuration of the electronic device 100A can be the same as and/or similar to that in Variation 1, but the processor for performing the same processing as that performed by the information processing device 20 may be omitted

As illustrated in FIG. 36, the information processing device 20 includes a CPU 21, a RAM 22, a storage 23, an operation display 24, and a communication unit 25, all of which are connected by a bus 26.

The CPU 21 is a processor that performs various arithmetic processing and overall controls operations of the various components of the information processing device 20. The CPU 21 performs various control operations by reading and executing a program 231 stored in the storage 23.

The RAM 22 provides a working memory space for the CPU 21 to store temporary data.

The storage 23 is a non-transitory recording medium that can be read by the CPU 21 as a computer. The storage 23 stores the program 231 executed by the CPU 21, various setting data, and the like. The program 231 is stored in the storage 23 in the form of computer-readable program code. A non-volatile storage device such as an SSD with flash memory or an HDD (Hard Disk Drive), for example, is used as the storage 23.

The operation display 24 includes a display device such as a liquid crystal display and an input device such as a mouse and keyboard. The operation display 24 displays various information, such as operation status, processing results and the like of the display system 1 on the display device. Here, the operation status of the display system 1 may include real-time images photographed by the camera 134 of the electronic device 100A. The operation display 24 converts the user's input operation on the input device into an operation signal, and outputs the operation signal to the CPU 21.

The communication unit 25 communicates with the electronic device 100A to transmit and receive data. For example, the communication unit 25 receives data including a part or all the detection results detected by the sensor unit 130A of the electronic device 100A and information relating to the operation (gesture) of the user detected by the electronic device 100A. The communication unit 25 may also be capable of communicating with devices other than the electronic device 100A.

In the display system 1 with such a configuration, the CPU 21 of the information processing device 20 executes at least part of the processing executed by the controller 190 of the electronic device 100A in Variation 1. For example, the CPU 21 may perform 3D mapping of the space 40 based on the detection result detected by the depth sensor 133. The CPU 21 may detect the user's viewing area 41 in the space 40 based on the detection results detected by the various components of the sensor unit 130A. The CPU 21 may generate the virtual image data 142 relating to the virtual image 30 in response to the operation of the user of the electronic device 100A. The CPU 21 may detect the position and orientation of the user's hand (and/or fingers) based on the images photographed by the depth sensor 133 and the camera 134.

The above processing results acquired by the CPU 21 are transmitted to the electronic device 100A via the communication unit 25. The controller 190 of the electronic device 100A operates each component (for example, the display 110A) of the electronic device 100A based on the received processing results. CPU 21 may transmit a control signal to the electronic device 100A to perform display control of the display 110A of the electronic device 100A.

Thus, by executing at least part of the processing in the information processing device 20, the device configuration of the electronic device 100A can be simplified and the manufacturing cost can be reduced. Further, by using a higher-performance information processing device 20, various processing related to MR can be made faster and more accurate. Thus, using the higher-performance information processing device 20 can improve the accuracy of the 3D mapping of the space 40, can improve the display quality of the display 110A, and can improve the response speed of the display 110A to user actions.

### [Others]

The above embodiments are examples, and various changes can be made.

For example, in the above Variation 1, the visor 114 having light transmissivity is used to allow the user to view the real space, but the present disclosure is not limited thereto. For example, a visor 114 having light shielding property may be used to allow the user to view an image of the space 40 photographed by the camera 134. In other words, the controller 190 may display, on display 110A, the image of the space 40 photographed by the camera 134 and the virtual image 30 superimposed on the image of the space 40. With such a configuration, MR that merges the virtual image 30 into the real space can be realized.

Further, by using a previously generated image of the virtual space instead of the image of the real space photographed by the camera 134, VR that makes the user feel as if he or she is in the virtual space can be realized. The user's viewing area 41 is also specified in the VR, and the virtual image 30, whose display position is determined within the viewing area 41 in the virtual space, is displayed.

The electronic device 100A is not limited to that having the annular main body portion 10a illustrated in FIG. 28, but may have any structure as long as the electronic device 100A has a display that can be viewed by the user when worn. For example, the electronic device 100A may cover the entire head of the user, like a helmet. The electronic device 100A may have a frame that hangs over the ears, like a pair of eyeglasses, with various devices built into the frame.

The above description is made based on an example in which the gesture of the user is detected and received as an input operation, but the present disclosure is not limited thereto. For example, an input operation performed by a controller held in the user's hand or worn on user's body may be received.

Variation 1 is described above is mainly focused on a network-related image specific to the wearable terminal device, which is the subject of the electronic device 100A, but various types of network-related images possible to be displayed in the electronic device 100 may also be displayed in the electronic device 100A.

The details of the configurations and controls described above in the embodiments may be changed as appropriate within a range not departing from the spirit of the present disclosure. The configurations and controls described above in the embodiments may be employed in combination as appropriate within a range not departing from the spirit of the present disclosure.

### INDUSTRIAL AVAILABILITY

The present disclosure may be used for an electronic device, a program and a display method.

### REFERENCE SIGNS

1 display system
100, 100A electronic device
110 touch panel display
110A display
111 touch panel
112 display
113 physical button
114 visor
115 laser scanner
121 voice input unit
122 voice output unit
130 sensor
130A sensor unit
131 acceleration sensor
132 angular velocity sensor
133 depth sensor
134 camera
135 eye tracker
140 storage
141 program
142 virtual image data
150 communication interface
151 cellular interface
152 WLAN interface
160 SIM interface
170 connection interface
180 battery
190 controller
20 information processing device
21 CPU
22 RAM
23 storage
231 program
24 operation display
25 communication unit
26 bus
30 virtual image
31 function bar
32 window shape changing button
33 close button
40 space
41 viewing area
51 virtual line
52 pointer
210 public cellular communication network
220 local cellular communication network
300 server
400 extension device
500 electronic device
600 electronic device
U user

1. An electronic device comprising:
a display; and
at least one circuitry,
wherein the at least one circuitry
acquires, from a communication network theoretically divided into a plurality of slices each corresponding to a service type, identifiers each assigned to a respective one of the plurality of slices via a communication interface, and
displays, based on the acquired identifiers, a first image indicating predetermined information about the communication network on the display.

2. The electronic device according to claim 1, wherein the first image is an image indicating number of slices corresponding to the communication network.

3. The electronic device according to claim 1, wherein the first image is an image indicating a feature of the communication network.

4. The electronic device according to claim 1,
wherein
the display includes a display member having light transmissivity, and
the at least one circuitry displays the first image on a display surface of the display member, the first image being viewed in a space that is visible through the display member.

5. The electronic device according to claim 1, further comprising:
a camera that photographs a space,
wherein
the at least one circuitry displays, on the display, an image of the space photographed by the camera and the first image superimposed on the image of the space.

6. The electronic device according to claim 4,
wherein the at least one circuitry
displays, on the display, a second image different from the first image and located in the space,
displays the first image while the first image is fixed in a predetermined position on the display and a user and the first image always face each other, and
displays the second image in a posture corresponding to an angle at which the user views the second image.

7. The electronic device according to claim 4,
wherein the at least one circuitry
displays, on the display, an object image having a first surface and a second surface located in the space,
displays the first image on the first surface, and
displays a third image different from the first image on the second surface.

8. The electronic device according to claim 7,
wherein the at least one circuitry switches, based on a predetermined operation, between
a first setting in which the object image is displayed while the first surface or the second surface is fixed on the display and the first surface or the second surface always faces a user, and
a second setting in which the object image is displayed in a posture corresponding to an angle at which the user views the object image.

9. The electronic device according to claim 1, wherein the at least one circuitry displays, on the display, the first image together with a fourth image indicating quality of communication with the communication network.

10. The electronic device according to claim 1, wherein the at least one circuitry displays the first image based on a predetermined operation.

11. The electronic device according to claim 10,
wherein the at least one circuitry
displays a third image different from the first image on the display, and
displays the first image based on a predetermined operation associated with the third image displayed on the display.

12. The electronic device according to claim 2, wherein the number of slices is number of slices satisfying a predetermined condition.

13. The electronic device according to claim 12, wherein the number of slices satisfying the predetermined condition is number of slices used before by the electronic device.

14. The electronic device according to claim 12, wherein the number of slices satisfying the predetermined condition is number of slices that satisfies predetermined communication amount or communication frequency.

15. The electronic device according to claim 12, wherein the number of slices satisfying the predetermined condition is number of slices that satisfies predetermined quality of communication.

16. The electronic device according to claim 1, wherein the at least one circuitry displays, on the display, a fifth image indicating the service types.

17. The electronic device according to claim 16, wherein the at least one circuitry displays the fifth image based on a predetermined operation associated with the first image displayed on the display.

18. The electronic device according to claim 4,
wherein the at least one circuitry
displays, on the display, an object image having a first surface and a second surface located in the space,
displays the first image on the first surface, and
displays a fifth image indicating the service types on the second surface.

19. The electronic device according to claim 16, wherein the at least one circuitry performs, based on a user operation to select one of the service types indicated on the fifth image, on/off control of use of communication via a slice corresponding to the selected service type.

20. The electronic device according to claim 1, further comprising:
a notifier,
wherein the at least one circuitry determines, based on the identifiers acquired via the communication interface, whether the number of slices corresponding to the communication network is changed, and if the number of slices corresponding to the communication network is changed, notifies such change via the notifier.

21. The electronic device according to claim 1, further comprising:
a notifier,
wherein the at least one circuitry determines, based on the identifiers acquired via the communication interface, whether the communication network includes a predetermined service type, and if the communication network includes the predetermined service type, notifies such inclusion via the notifier.

22. The electronic device according to claim 21, wherein the predetermined service type is a service type uniquely recommended for the electronic device.

23. The electronic device according to claim 21, wherein the predetermined service type is a service type uniquely recommended for at least one application executed in the electronic device.

24. The electronic device according to claim 1,
wherein, when the communication network is a local cellular communication network, the at least one circuitry
acquires, via the communication interface, owner information indicating an owner of a license corresponding to the local cellular communication network, and
displays, based on the owner information, a sixth image indicating the owner on the display.

25. The electronic device according to claim 24, wherein the at least one circuitry displays, based on a predetermined operation associated with the sixth image displayed on the display, a guide image enabling access to the owner on the display.

26. The electronic device according to claim 1,
wherein, when the communication network is a local cellular communication network, the at least one circuitry
acquires, via the communication interface, communication area information indicating a communication area of the local cellular communication network, and
displays, based on the communication area information, a seventh image indicating the communication area on the display.

27. The electronic device according to claim 26, wherein the at least one circuitry displays, based on a predetermined operation associated with the seventh image displayed on the display, a map image indicating the communication area on the display.

28. A non-transitory computer-readable storage medium storing a program causing a computer installed in an electronic device equipped with a display to execute processing comprising:
acquiring, from a communication network theoretically divided into a plurality of slices each corresponding to a service type, identifiers each assigned to a respective one of the plurality of slices via a communication interface; and
displaying, based on the acquired identifiers, an image indicating predetermined information about the communication network on the display.

29. A display method in an electronic device equipped with a display, comprising:
acquiring, from a communication network theoretically divided into a plurality of slices each corresponding to a service type, identifiers each assigned to a respective one of the plurality of slices via a communication interface; and
displaying, based on the acquired identifiers, an image indicating predetermined information about the communication network on the display.
